(19) United States
(12) Patent Application Publication
(10) Pub. No.: US 2012/0030878 A1
(43) Pub. Date: Feb. 9, 2012

(54) Positioning Apparatus For Preventing Decubitus Ulcers

(76) Inventors: Thomas Davenport, Manhasset, NY (US); Steven Stavrides, Wantagh, NY (US)

(21) Appl. No.: 12/851,885

(22) Filed: Aug. 6, 2010

(51) Int. Cl. A61G 7/057

(52) U.S. Cl. 5/655.3

(57) ABSTRACT

An apparatus and method for preventing and/or inhibiting decubitus ulcers including a pad having first and second interconnected sections which form an open region there between. The first pad section includes a first chamber and the second pad section includes a second chamber. The first and second chambers are independently and selectively inflatable and deflatable to change the shape of the pad. The pad has an upper surface adapted to engage a user, the upper surface including a device for removably securing the pad to a user.

### FIELD OF INVENTION

The present invention relates to an apparatus for positioning an individual and, more particularly, to an apparatus for positioning the sacral region of an individual in order to prevent and/or inhibit decubitus ulcers.

### BACKGROUND

Individuals who are bed bound or confined to a wheel chair for long periods of time are at risk for developing decubitus ulcers, commonly referred to as bedsores or pressure sores. The ulcers typically appear and develop at the location of a bony prominence on a patient's body and the immediate area of such bony prominence. The ulcers are caused by direct contact pressure by an object (such as furniture, e.g., a bed; wheel chair; operating table; etc.) with such bony prominence and its surrounding area. Sustained pressure cuts off circulation to vulnerable parts of the body, especially the skin on the buttocks, hips and heels. Without adequate blood flow, the affected tissue dies. These ulcers can develop quickly and progress rapidly and are often difficult to heal. Once developed, they can lead to infection and seriously impact the wellbeing of the patient.

Decubitus ulcers can range from a very mild pink coloration of the skin, which disappears in a few hours after pressure is relieved on the area, to a very deep wound extending to and sometimes through a bone into internal organs. These ulcers are classified in stages according to severity.

The portion of the back adjacent the sacrum is most prone to such ulcers due to the proximity of the bones to the skin's surface and the amount of weight bearing on this area. The sacrum is at the bottom of the spine. Its upper part connects with the last lumbar vertebra, and its bottom part with the coccyx (tailbone). An ulcer on this sacral region may develop rather quickly, such as when a patient remains in one position on an operating table during an extended operation.

Since the ulcers are difficult to treat, it is important that attention is given to prevent them from forming. The classic procedure for prevention is for a caregiver to rotate a patient every two hours so that pressure can be relieved and no single area of the body is endures prolonged periods of pressure. While effective, this procedure requires a significant amount of staffing and strict adherence to schedules to be effective. Furthermore, in surgical settings, manually shifting the position of a patient can be disruptive to the ongoing procedure.

Various systems and devices exist for shifting the pressure exerted on an immobilized individual. These systems include beds having movable sections; however, such beds are expensive and impractical for large institutions treating many individuals. For surgical situations, where a sterile environment is essential, devices must be properly cleaned after each use. Such maintenance adds significant complexity and cost.

Accordingly, it would be desirable to provide an economical device, which is easy to use and requires little or no maintenance, for shifting the position of an immobilized individual to prevent and/or inhibit decubitus ulcers.

### SUMMARY

The present invention provides an apparatus for preventing and/or inhibiting decubitus ulcers including a pad having first and second interconnected sections forming an open region there between. The first pad section includes a first chamber and the second pad section includes a second chamber. The first and second chambers are independently and selectively inflatable and deflatable to change the shape of the pad. The pad has an upper surface adapted to engage a user, the upper surface including a device for removably securing the pad to a user.

The present invention further provides a kit for preventing and/or inhibiting decubitus ulcers including a pad having first and second interconnected sections forming an open region there between. The first pad section includes a first chamber and the second pad section includes a second chamber. The first and second chambers are independently and selectively inflatable and deflatable to change the shape of the pad. The kit also includes tubing for operably connecting the first and second chambers to a source of pressurized fluid. An outer wrapper is provided for receiving therein the pad and tubing, and the outer wrapper is hermetically sealed.

The present invention still further provides a method of preventing and/or inhibiting decubitus ulcers including: positioning a pad between a user and a support surface, the pad including first and second interconnected sections forming an open region there between; locating the pad with respect to the user wherein the pad surrounds the sacral area and the sacral area aligns with the open region; changing the shape of the pad to orient the user in a first position; and after a predetermined time, changing the shape of the pad to orient the user in a second position different from the first position.

### BRIEF DESCRIPTION OF THE DRAWINGS:

FIG. 1 is perspective view of positioning apparatus;

FIG. 2. is a top plan view of the of the positioning apparatus of FIG. 1;

FIG. 3 is an elevational view of the positioning apparatus attached to an individual;

FIG. 4A is a side view showing the positioning apparatus in a first position;

FIG. 4B is a side view showing the positioning apparatus in a second position;

FIG. 4C is a side view showing the positioning apparatus in a third position;

FIG. 5 is a side elevational view of the positioning apparatus; and

FIG. 6 is a top plan view of a positioning apparatus kit.

### DETAILED DESCRIPTION OF PREFERRED EMBODIMENTS:

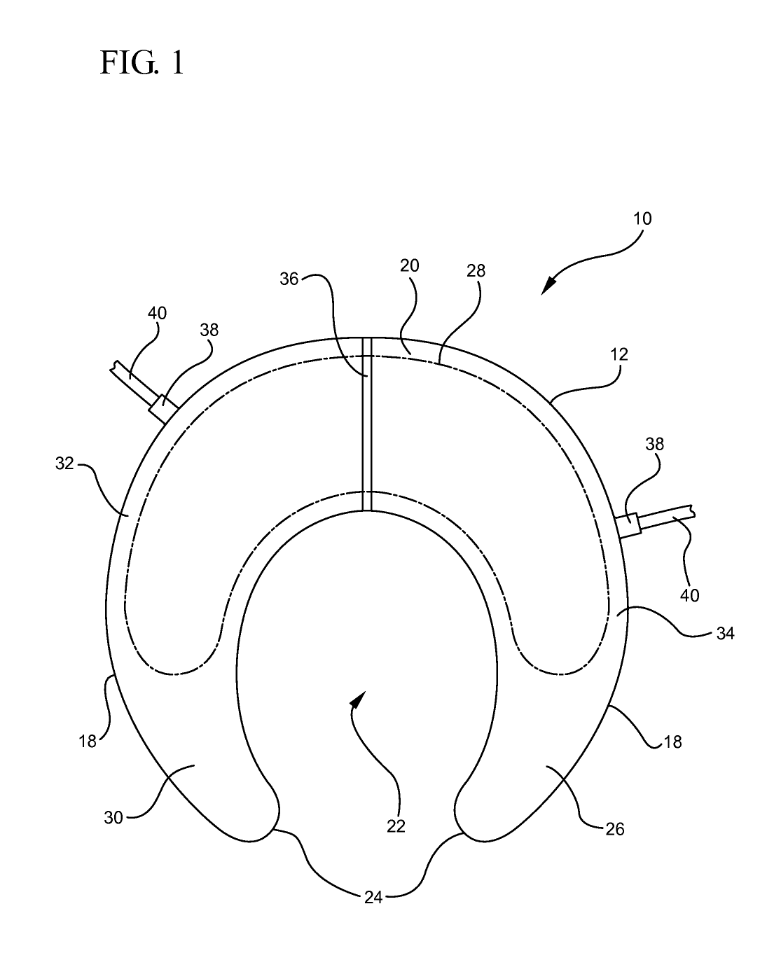

With reference to FIGS. 1-4, a positioning apparatus 10 is shown. The apparatus 10 may include a pad 12 operably connected to a fluid supply unit 14. The shape of the pad 12 can be changed in order to shift the weight of a patient 15. The pad 12 may be placed between a patient and a support surface 17, such as a bed or operating table. The apparatus 10 may selectively shift the position of a patient from side to side. Such shifting prevents the weight of the patient 15 from being supported for prolonged periods by one portion of the patient's body, thereby preventing and/or inhibiting the formation of decubitus ulcers. The positioning apparatus 10 can also support an area of a patient's body having decubitus ulcers, and/or other wounds, above a support surface 17 and can be used to promote the treatment and healing of such ulcers and/or other wounds.

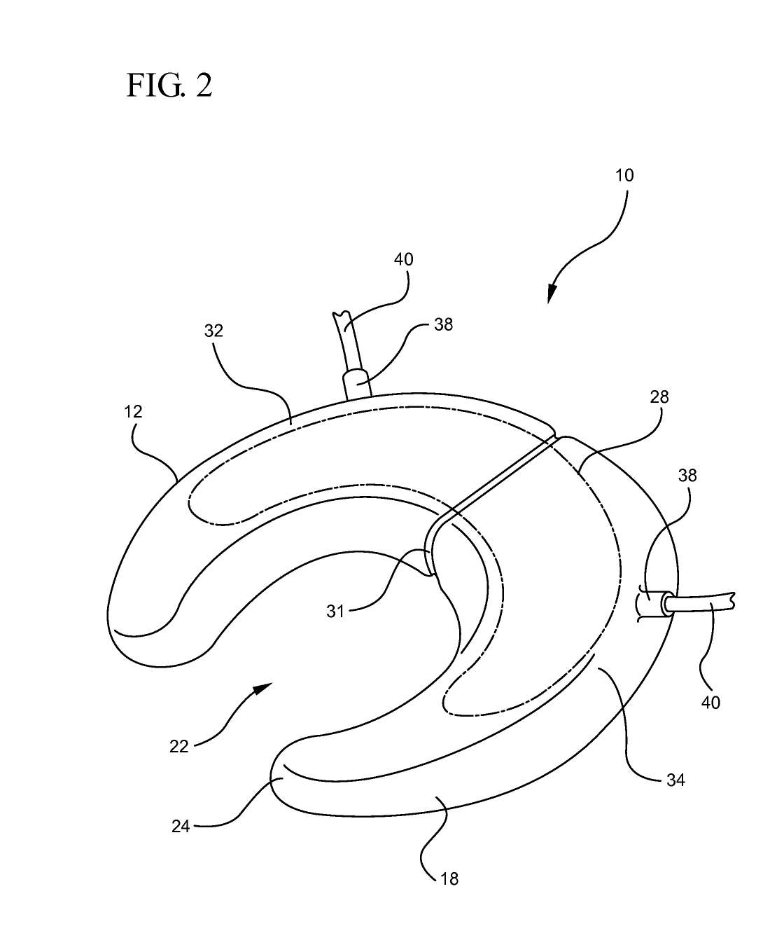

As shown in FIGS. 1 and 2, pad 12 may have a C-shape or horseshoe-like shape including a pair of lobe-like sections 18 which are connected to each other at a central section 20. The distal ends of the lobes 24 may curve inwardly toward each other. It is within the contemplation of the present invention that the pad may have other shapes. The pad 12 defines an open region 22 between the two lobes 18.

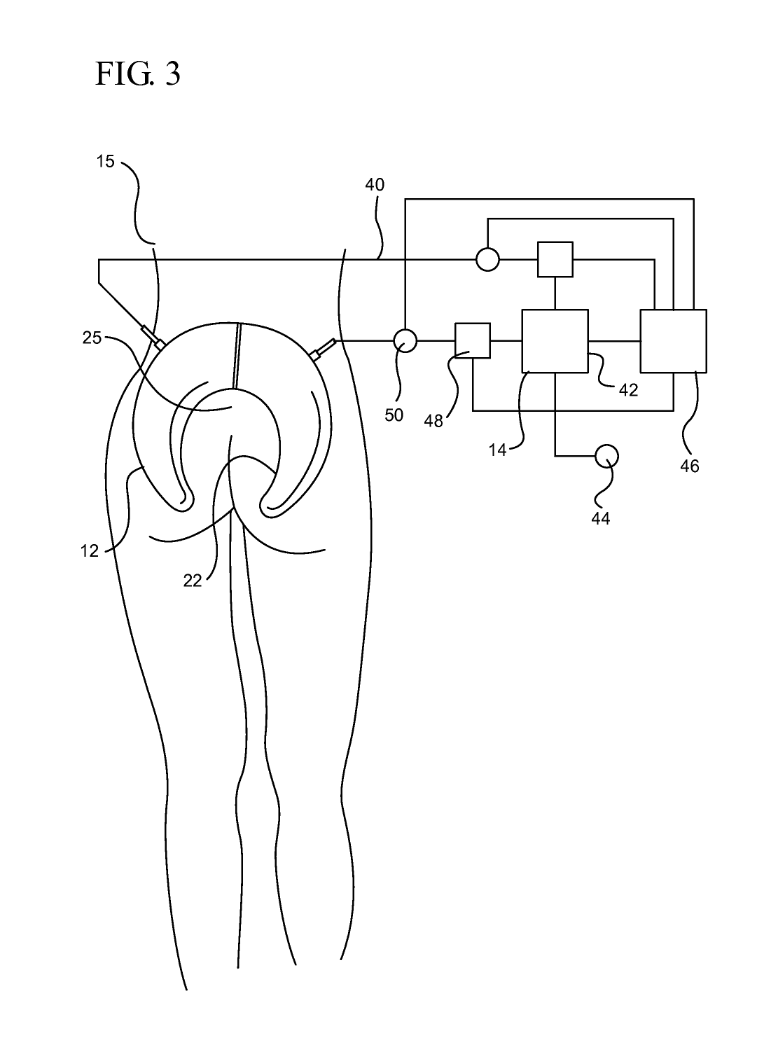

The pad 12 may be placed around a patient's sacral region 25, as shown in FIG. 3. The sacral region is the area of the back overlying the sacrum. The sacral region 25 is especially prone to decubitus ulcers since the sacrum bone is relatively close to the skin's surface and a significant amount of weight is supported by this area. The proper placement of the pad 12 is important to ensure that the sacral region is adequately supported. The open region 22 of the pad is preferably positioned over the sacral region so that the sensitive sacral region is supported above and displaced from the bed or other support structure 17 without pressure from the pad 12 being exerted thereon. The pad lobes 18 may extend along the portion of the body where the bones are relative far from the skin's surface such as the buttocks and/or upper thighs as these areas are less susceptible to developing ulcers. Such placement allows the sacral region to be shifted by the positioning apparatus 10, thereby relieving pressure from any one section of the body. By relieving pressure, blood flow may freely circulate thereby maintaining and/or restoring vitality to the skin and preventing and/or inhibiting the formation of ulcers.

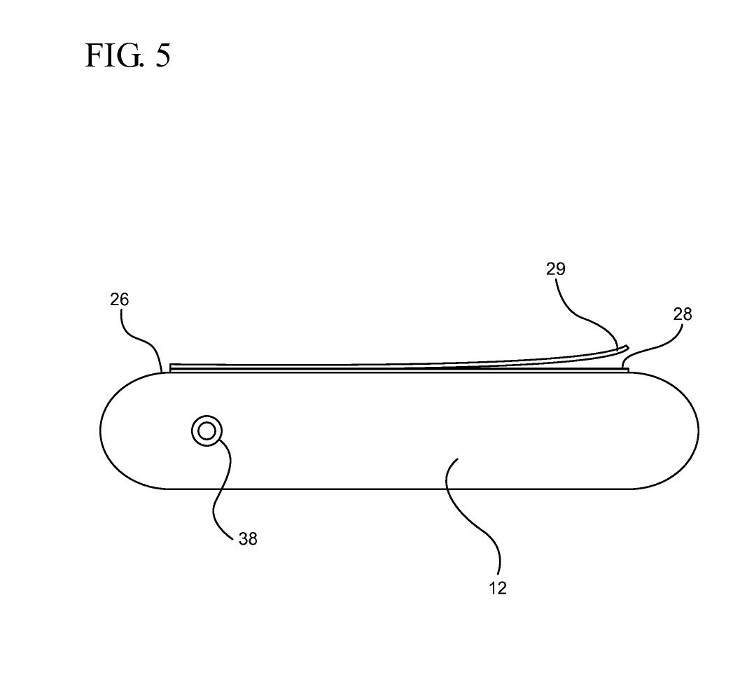

In order to maintain the pad in place, the pad 12 may include an attachment surface 26 which adjoins the pad to a patient. With reference to FIG. 5, the attachment surface 26 may include an adhesive layer 28 so that the pad can be placed directly onto the patient. The adhesive layer 28 may include a relatively low tack adhesive so that it can be easily removed without causing any harm to the skin. The adhesive may allow the pad to be removed and reattached to the patient as needed. Such low tack, reusable adhesives are well known in the art. Alternatively, the pad 12 could be attached to the patient's clothing. The adhesive layer 28 prevents the pad 12 from shifting and eliminates the need for straps or other securement devices. The adhesive layer 28 may be covered by a release layer 29 which when removed exposes the adhesive layer for use. The adhesive layer 28 may cover the entire attachment surface 26 or only a portion thereof.

Once secured in place, the pad 12 may be used to change the position of the patient in order to redistribute the weight and relieve pressure from an area of the body. The repositioning of the patient can be achieved by selectively changing the shape of the pad 12. The pad 12 may have a plurality of sealed fluid-tight chambers 30 which may be independently inflated and deflated. Therefore, the shape change may be achieved by selectively inflating and deflating the chambers 30. In a preferred embodiment, the pad may have a first 32 and second 34 chamber separated by an internal wall 36 disposed at the central section 20 of the pad. The first chamber 32 may be formed in one of the pad lobes 18 and the second chamber 34 may be formed in the other pad lobe 18. Each of the first and second chambers includes a port 38 to which one end of a fluid line 40 may be attached. The other end of the fluid lines 40 may be attached to the fluid supply unit 14. The manner of attachment between the ports 38 and fluid supply unit 14 may be such that both ends of the fluid lines can be removed.

The pad 12 may be formed of thin layers of pliable material such as vinyl, rubber, polyvinyl chloride, PVC, or other material known in the art. The material may be such that it can be sealed to permit the retention of fluid such as, for example, air, water, oil and saline. The layers may be joined together such as by heat welding to form the first and second chambers 32 and 34. The pliable material may be covered by an outer covering such as a woven or non-woven cloth to increase the comfort of the pad. In such an embodiment, the attachment surface may be disposed on the covering.

With reference to FIG. 3, the fluid supply unit 14 may include one or more valves 42 operatively connected to the fluid lines 40. The valve 42 is also connected to a fluid source 44 such as compressed air or other gas generated from a bottle of compressed gas or a pump. The supplied fluid may also be a liquid such as saline solution, water or oil. The valve 42 may selectively inflate and deflate the chambers 32 and 34. The valve 42 may also permit both chambers to be inflated at the same time and to be deflated at the same time. A single valve as shown in FIG. 3 may be used or, alternatively, two valves with one valve for each fluid line 40, may be employed.

The valve 42 may be operably connected to a controller 46. The controller may be of a primarily mechanical type, such as a push button or switch, which would permit a caregiver to manually actuate the valve. A caregiver may adjust the level of inflation and deflation in the two chambers 32 and 34 to obtain the desired patient position.

Alternatively, the controller 46 may automatically inflate and deflate the first and second chambers 32 and 34 in accordance with a predetermined schedule. The controller may generate a signal which causes the valve 42 to shift to obtain the desired flow of fluid. When the first chamber 32 is to be inflated, the valve 42 would be actuated to permit air enter the chamber. The second chamber 34 may simultaneously be exhausted to atmosphere. The weight of the patient would tend to deflate the exhausted chamber. Manual overrides could be included in the controller to permit a caregiver to manually adjust the level of inflation in the first and second chambers 32 and 34 as desired.

The fluid supply unit 14 may further include pressure sensors 48 that sense the pressure in each chamber 32 and 34. A flow sensor 50 may also be disposed in the fluid lines so that the volume of fluid in the chambers can be monitored. The pressure sensors 48 and flow sensors 50 may be operably connected to the controller. The controller 46 may include a processor which may determine the degree of inflation based on the pressure and volume of fluid in the first and second chambers 32 and 34.

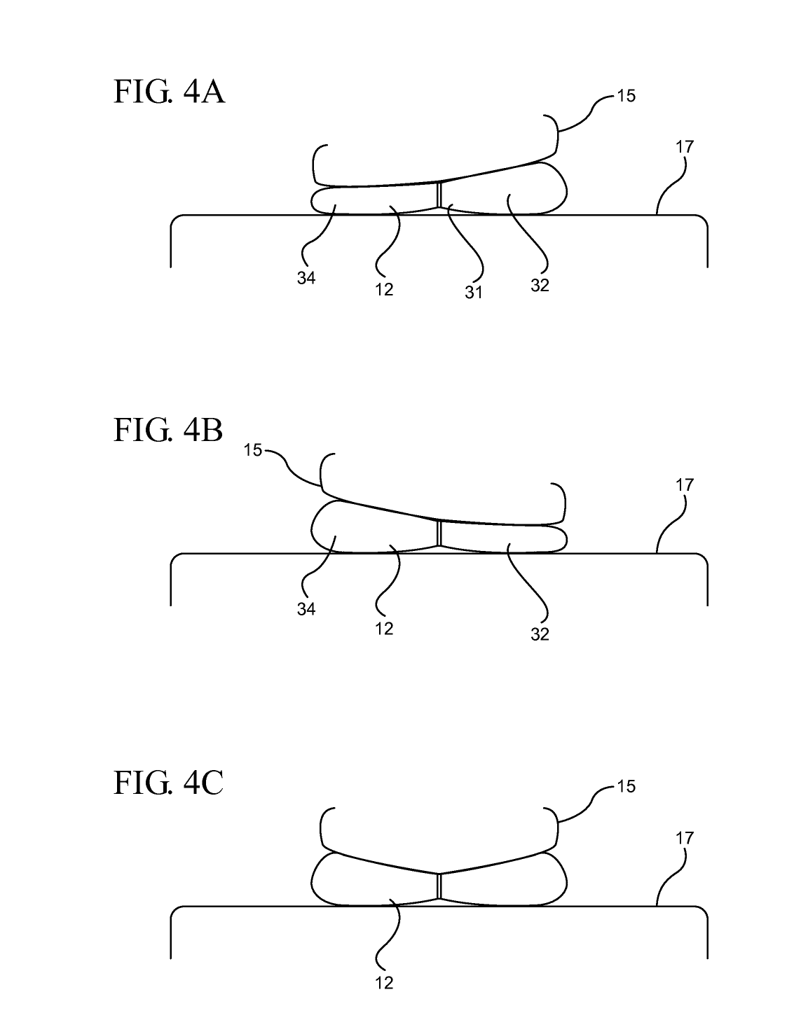

With reference to FIGS. 4A-C, by adjusting the level of inflation of the chambers 30, the shape of the pad 12 may be changed to shift the weight of a patient 15 and, in particular, to shift the lower back and hips to prevent prolonged pressure being exerted on one area of the body by the support surface 17. The shifting of the weight helps promote air and blood circulation at, or in the vicinity, which was previously bearing the patient's weight, thereby preventing and/or inhibiting the formation of decubitus ulcers. As shown in FIG. 4A, the first chamber 32 is inflated and second chamber 34 is deflated which tends to position a patient 15 toward the left side. In FIG. 4B, the second chamber 34 is inflated and first chamber 32 is exhausted. This tends to shift the patient 15 to the right. Both the first and second chambers 32 and 34, may be simultaneously inflated to provide a third position of support shown in FIG. 4C which raises the patient 15 above the support surface 17.

It is further contemplated that the amount of inflation and deflation of the first and second chambers 32 and 34 can be controlled to obtain the desired pad shape. For example, to obtain a desired patient position, one chamber could be partially deflated and the other fully inflated. Such flexibility to control the shape of the pad 12 permits the pad to have various functions. For example, in addition to preventing the formation of decubitus ulcers, the positioning system 10 may also be used to remove pressure from existing wounds such as sores or ulcerations. Each chamber 32 and 34 may be maintained at a minimum level of inflation so that any wound is elevated above the support surface 17 such as shown in FIG. 4C.

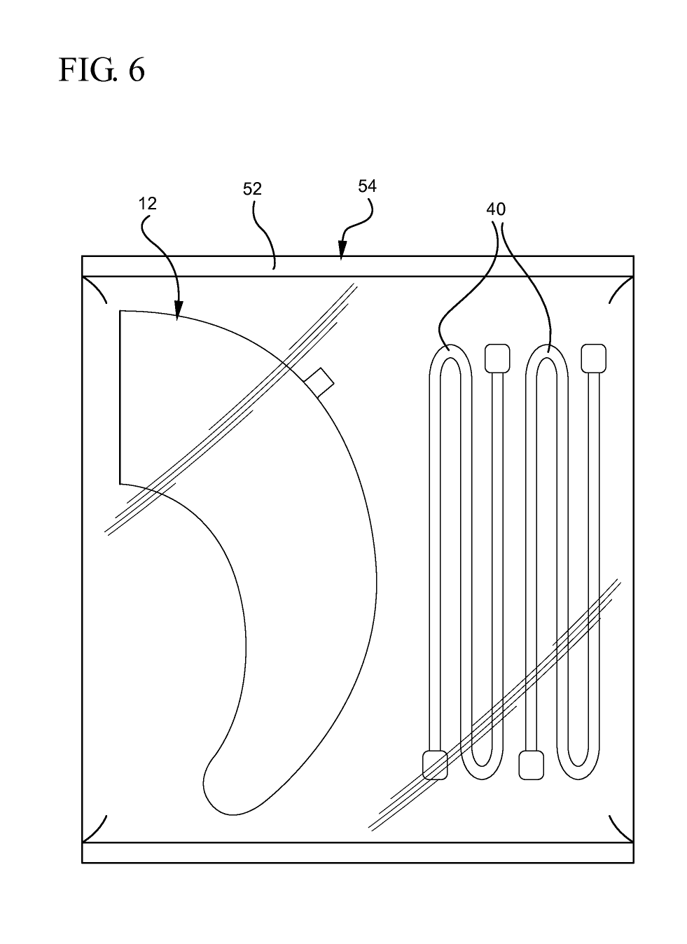

With reference to FIG. 6, the pad 12, when fully deflated may be folded into a compact shape, making it easy to transport and store. The pad 14 may be sterilized and hermetically sealed in an outer packaging 52. Sterilized fluid lines 40 may also be packaged with the pad 12 forming a kit 54. When the pad 12 is needed for use, it can be removed from the packaging 52. The release layer 29 can be removed from the adhesive surface, and the sterile pad 12 can be applied to a patient. Since the portion of the positioning apparatus 10 that comes into contact with a patient is packaged in a sterile condition, the pad 12 may be used in a sterile environment such as an operating room.

The pad 12 may be formed of relatively inexpensive material such that it may have a single use application. After the pad 12 is used on a patient, it can be disposed of, thereby avoiding the cost of cleaning The pad can also be changed frequently thereby reducing the risk of infection.

It will be appreciated that variations of the above-disclosed and other features and functions, or alternative thereof, may be desirably combined into many other different systems or applications. Various presently unforeseen or unanticipated alternatives, modifications, variations, or improvements therein may be subsequently made by those skilled in the art which are also intended to be encompassed by the following claims. In addition, the claims can encompass embodiments in hardware, software, or a combination thereof.

What is claimed is:

1. An apparatus for preventing and/or inhibiting decubitus ulcers comprising:
a pad having first and second interconnected sections forming an open region there between, the first pad section including a first chamber and the second pad section including a second chamber, the first and second chambers being independently and selectively inflatable and deflatable to change the shape of the pad; and
the pad having an upper surface adapted to engage a user, the upper surface including a device for removably securing the pad to a user.

2. The apparatus of claim 1, wherein the pad has a generally U-shaped configuration.

3. The apparatus of claim 1, further including a valve for controlling the inflation and deflation of the first and second chambers.

4. The apparatus of claim 3, further including a controller operably connected to the valve for selectively inflating or deflating the first and second chambers in a predetermined sequence.

5. The apparatus of claim 1, wherein the first and second inflatable chambers include a port operably connectable to a pressurized fluid source.

6. The apparatus of claim 1, wherein the device for removably securing the pad to the user includes an adhesive layer.

7. The apparatus of claim 6, wherein the adhesive layer has a relatively low tack.

8. The apparatus of claim 6, further including a release layer for covering the adhesive layer prior to use.

9. The apparatus of claim 1, wherein the first and second chambers are fluidly isolated from one another.

10. A kit for preventing and/or inhibiting decubitus ulcers comprising:
a pad having first and second interconnected sections forming an open region there between, the first pad section including a first chamber and the second pad section including a second chamber, the first and second chambers being independently and selectively inflatable and deflatable to change the shape of the pad;
tubing for operably connecting the first and second chambers to a source of pressurized fluid; and
an outer wrapper for receiving therein the pad and tubing, the outer wrapper being hermetically sealed.

11. The kit as defined in claim 10, wherein the pad having an upper surface adapted to engage a user, the upper surface including a device for removably securing the pad to a user.

12. The kit as defined in claim 10, further including a valve operably connectable to the first and second inflatable chambers via the tubing.

13. A method of preventing and/or inhibiting decubitus ulcers comprising:
positioning a pad between a user and a support surface, the pad including first and second interconnected sections forming an open region there between;
locating the pad with respect to the user wherein the pad surrounds the sacral area and the sacral area aligns with the open region;
changing the shape of the pad to orient the user in a first position; and
after a predetermined time, changing the shape of the pad to orient the user in a second position different from the first position.

14. The method of claim 13, wherein the pad further includes an adhesive layer and securing the pad to the user with the adhesive layer.

15. The method of claim 13, wherein the pad at least partially encircles the sacral area.

16. The method of claim 13, wherein the pad has a generally U-shaped configuration.

17. The method of claim 13, wherein the first pad section includes a first chamber and the second pad section includes a second chamber, the first and second chambers being independently and selectively inflated and deflated to change the shape of the pad.

18. The method of claim 17, including inflating the first chamber and deflating the second chamber to move a user to the first position.

19. The method of claim 18, including inflating the second chamber and deflating the first chamber to move a user to the second position.

20. The method of claim 19, including inflating the first chamber and inflating the second chamber to move a user to a third position.
